(19) United States
(12) Patent Application Publication
(10) Pub. No.: US 2004/0221841 A1
(43) Pub. Date: Nov. 11, 2004

(54) Breathing apparatus for reducing fogging of lenses caused by breath vapor

(76) Inventor: David Matthew Herschel, New Orleans, LA (US)

Correspondence Address: DAVID M. HERSCHEL, 239 CYPRESS GROVE CT, NEW ORLEANS, LA, 70131, US

(21) Appl. No.: 10/429,586

(22) Filed: May 5, 2003

(51) Int. Cl. A62B 18/08

(52) U.S. Cl. 128/201.26; 128/201.25; 128/205.27; 128/205.29

(57) ABSTRACT

A breathing apparatus for hunting in colder temperatures that reduces fogging of eye glasses, rifle scopes, or camera lenses by redirecting breath vapor behind the body with a snorkel device with a flexible hose, and a breath scent carbon filtered exhaust. The device is provided a neck gator to attach the device to the hunter or nature enthusiast by pulling the device over the head and onto the neck.

### BACKGROUND OF THE INVENTION

This invention relates generally to the field of hunting aids and more specifically to a breathing apparatus for hunting in colder temperatures that reduces fogging of eye glasses, rifle scopes, or camera lenses by redirecting breath vapor behind the body. Prior devices in the field of human scent control for hunters and nature watchers include scent masking clothing, animal scent imitation sprays, and similar devices which mask or cover up human scent. Cold weather masks and other apparel, whether scent masking or not, do not redirect breath vapor to prevent fogging of eye glasses or other glass devices in cold weather.

The snorkel is a multi-patented device which is primarily used as a breathing device for underwater swimming or diving. Carbon filtering has been used in many patents for air cleaners and venting or filtering of various gasses.

Most of the scent control devices and apparel do not remove or dissipate the human scent. Face masks, such as Baughman et al., U.S. Pat. No. 6,070,578 (2000), and other apparel for reducing scent and maintaining warmth can still result in fogged eye glasses, camera view finders, or rifle scopes. Other designs, such as U.S. Pat. No. 5,117,821 to White (1992), are bulky and difficult to remove and replace on the face which could result in scaring away target game; these designs also do not necessarily accommodate wearing of eye glasses during use. This design has no moving parts or valves, making it very easy to clean and maintain.

### BRIEF SUMMARY OF THE INVENTION

One object of the invention is to provide hunters and nature enthusiasts that wear eye glasses a device to keep them from fogging up in colder temperatures.

Another object of the invention is to provide a human scent control device to hunters and nature enthusiasts that significantly reduces their upwind scent signature allowing for much closer visual contact with desired species.

Another object of the invention is to provide a breath driven personal heater to hunters and nature enthusiasts during very cold conditions by placing snorkel exhaust under outer wear.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a breathing apparatus for hunting in colder temperatures that reduces fogging of eye glasses, rifle scopes, or camera lenses by redirecting breath vapor behind the body. The breathing apparatus of the present invention comprises a snorkel device with a flexible hose, and a breath scent carbon filtered exhaust.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the hunting snorkel according to the present invention.

FIG. 2 is a plan view of the hunting snorkel according to the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

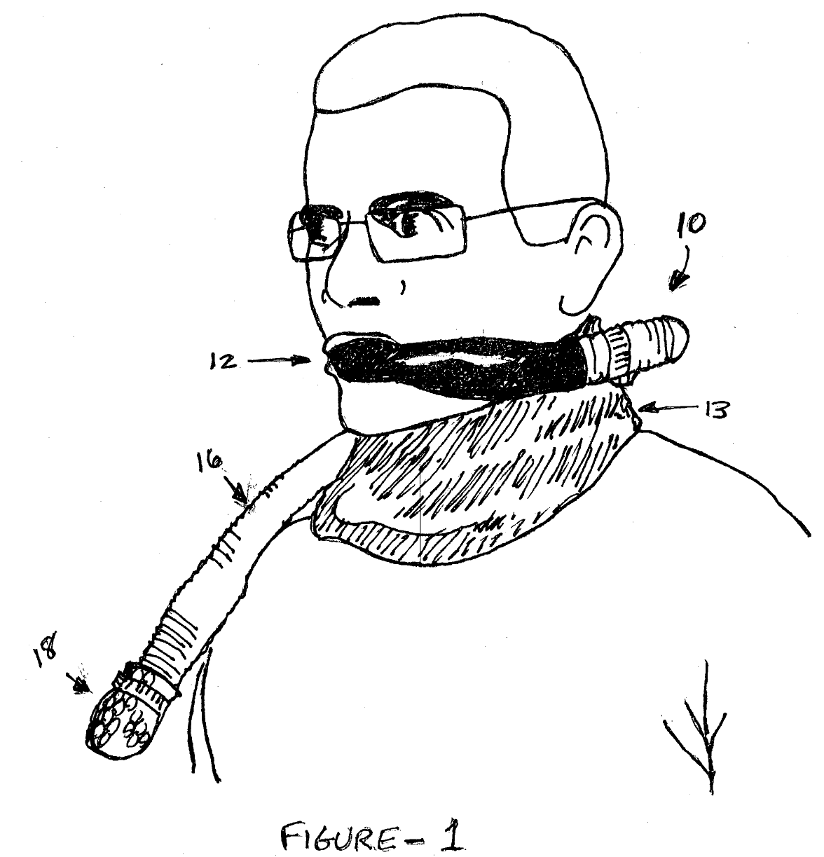

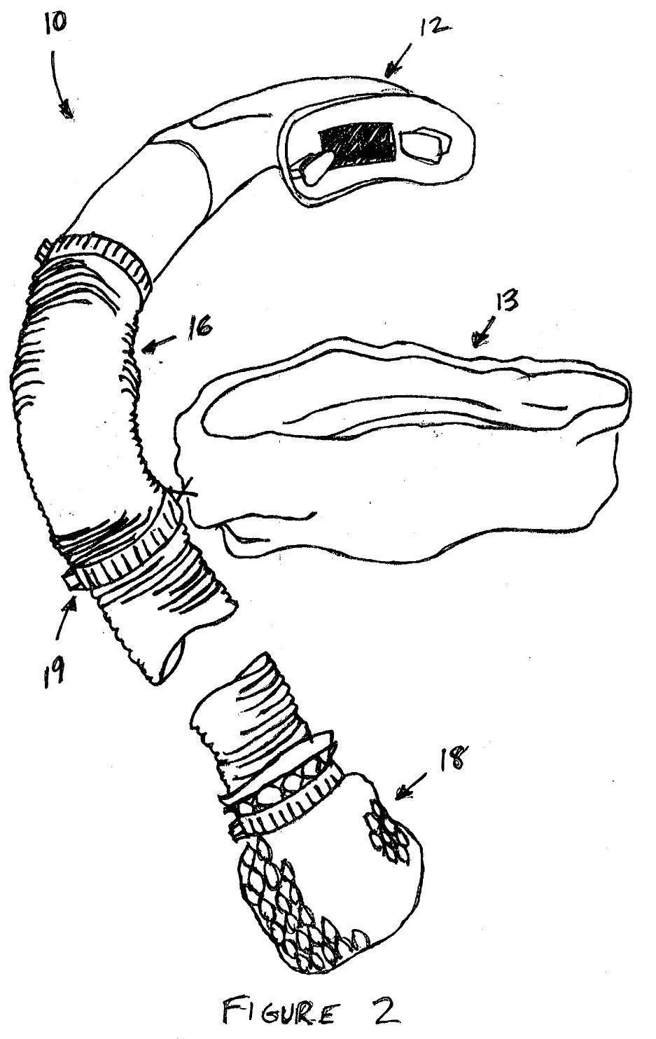

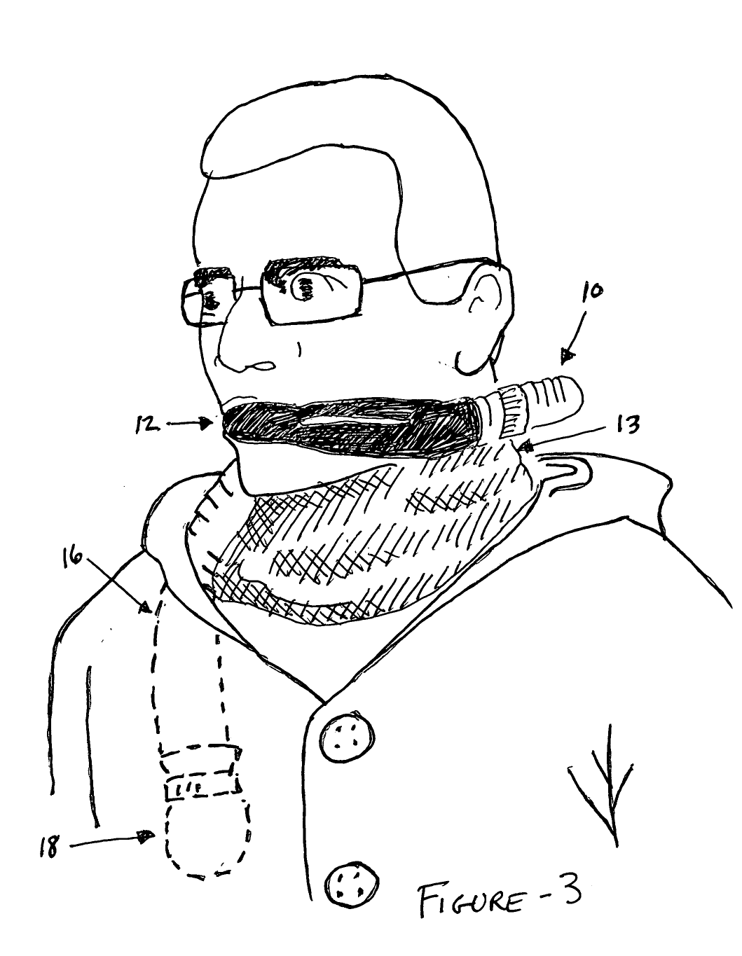

Turning first to FIG. 1. FIG. 1 is a perspective view of the hunting snorkel 10 according to the present invention. The hunting snorkel 10 comprises a mouthpiece 12 of conventional construction which is adapted to fit the mouth of the hunter. A suitable resilient neck strap (gator) 13 maintains the snorkel 10 in position. The nose of the hunter allows for the admission of ambient air and a flexible exhalation tube 16 is connected to the mouthpiece 12 which leads to an air purifying bag or canister 18 containing, for example, charcoal granules. One advantage of the bag or canister 18 at the end of the flexible tube 16 is that the bag or canister 18 can be placed inside the hunter's outer clothing whereby exhaled breath functions to warm the body and therefore breath scent is further filtered out. FIG. 2 is a plan view of the hunting snorkel 10 showing component parts of FIG. 1 connected together by three hose clamps 19.

In operation, normal breathing by the hunter draws ambient air through the hunter's nose. Exhaled breath flows through the tube 16 to the bag/canister 18 and then exhausts to the ambient atmosphere. This apparatus when worn in colder temperatures reduces fogging eye glasses, rifle scopes, and camera lenses by redirecting warm breath vapor behind the body or under outer clothing wear.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A breathing apparatus for hunting comprising:
a snorkel device having a mouthpiece adapted to fit the mouth of a hunter and a flexible hose connected to said mouthpiece; and
a breath scent carbon filtered exhaust connected to said flexible hose:
wherein said breathing apparatus redirects breath vapor away from the hunter's face.

2. The breathing apparatus of claim 1 further comprising a resilient neck strap for maintaining said snorkel device in position.

3. The breathing apparatus of claim 1 wherein said breathing apparatus is adapted to redirect breath vapor behind the hunter's body.

4. The breathing apparatus of claim 1 wherein said breathing apparatus is adapted to redirect breath vapor to the inside of a hunter's outer clothing.
